(19) United States
(12) Patent Application Publication
(10) Pub. No.: US 2022/0154599 A1
(43) Pub. Date: May 19, 2022

(54) AIRCRAFT INTERNAL COMBUSTION ENGINE

(71) Applicant: HONDA MOTOR CO., LTD., Tokyo (JP)

(72) Inventor: Hisao Haga, Wako-shi (JP)

(21) Appl. No.: 17/522,955

(22) Filed: Nov. 10, 2021

(30) Foreign Application Priority Data
Nov. 17, 2020 (JP) 2020-190853

(51) Int. Cl. F01D 25/20; B64D 27/14; F01M 1/16; F02C 7/06

(52) U.S. Cl. CPC F01D 25/20; B64D 27/14; F01M 1/16; F05D 2220/323; F05D 2270/303; F05D 2260/98; F05D 2270/304; F02C 7/06

(57) ABSTRACT

Provided is an aircraft internal combustion engine capable of improving a fuel consumption rate. An aircraft internal combustion engine (1) includes a gas turbine (2), a lubricating oil supply pipe (31) through which a lubricating oil flows, a variable capacity type electric pump (33) that supplies the lubricating oil to the gas turbine (2), a temperature detection unit (5) that detects the temperature of the lubricating oil, a supply amount detection unit (6) that detects a supply amount of the lubricating oil, a rotation speed detection unit (4) that detects a rotation speed of the gas turbine (2), and a control unit (7). The control unit (7) sets a target supply amount of the lubricating oil based on the rotation speed of the gas turbine (2) detected by the rotation speed detection unit (4) and the temperature of the lubricating oil detected by the temperature detection unit (5), and controls a discharge amount of the lubricating oil such that the supply amount of the lubricating oil detected by the supply amount detection unit (6) matches the target supply amount.

### CROSS-REFERENCE TO RELATED APPLICATION

Priority is claimed on Japanese Patent Application No. 2020-190853, filed Nov. 17, 2020, the content of which is incorporated herein by reference.

### BACKGROUND OF THE INVENTION

### Field of the Invention

The present invention relates to an aircraft internal combustion engine.

### Description of Related Art

In the related art, there is a configuration of an aircraft internal combustion engine that is mounted on the airframe of an aircraft and uses a gas turbine engine as a power source for propelling the aircraft. In the configuration of most gas turbine engines of the related art, a lubricating oil is supplied to an engine with a mechanical pump connected to a main shaft of the engine via a drive shaft. FIG. 5 is a graph showing a relationship between an engine speed and an oil pressure according to the related art. The graph G101 of FIG. 5 indicates an engine required oil pressure for each engine speed. The graph G102 of FIG. 5 indicates an actual oil pressure of a lubricating oil supplied from a mechanical pump according to an engine speed. As indicated by the graph G102 of FIG. 5, in the mechanical pump of the related art, an oil pressure of the lubricating oil changes according to a change in the engine speed. Thus, there is a large waste of actual oil pressure, that is, the amount of an actually supplied lubricating oil with respect to the required oil pressure (refer to the graph G101), and it may be difficult to stably secure a supply amount of the lubricating oil. Therefore, various techniques for supplying a lubricating oil by using an electric pump capable of stably supplying the lubricating oil regardless of the engine speed have been proposed.

For example, Patent Document 1 (Japanese Unexamined Patent Application, First Publication No. 2020-37925) discloses a supply device that supplies a lubricating oil to bearings of a gas turbine engine, the supply device having a configuration including an air extraction pipe that communicates with a compressor and has an injection port on the bearing side, an oil pipe that connects an oil tank to the air extraction pipe, and an electric pump that is provided in the middle of the oil pipe and sucks the lubricating oil from the oil tank and supplies the lubricating oil to the air extraction pipe. The lubricating oil is supplied from the oil tank to high-pressure air flowing through the air extraction pipe communicating with a compressor by the electric pump, and oil mist generated thereby is supplied to the bearings.

According to the technique disclosed in Patent Document 1, a constant amount of lubricating oil can be supplied regardless of the engine speed by using the electric pump.

### SUMMARY OF THE INVENTION

However, in the technique disclosed in Patent Document 1, since the supply amount of lubricating oil is constant, for example, even in a case where the load on the engine is small, a larger amount of lubricating oil may be supplied than the required amount of oil. Therefore, there is concern that the supply amount of lubricating oil may become excessive, especially in a case where the load on the engine is small and the required amount of oil is small Consequently, electric power related to driving a pump is wasted, and thus there is concern that the fuel consumption rate may deteriorate.

Therefore, an object of the present invention is to provide an aircraft internal combustion engine capable of improving the fuel consumption rate.

An aircraft internal combustion engine according to the present invention has the following configuration.

(1) According to an aspect of the present invention, an aircraft internal combustion engine is provided including a gas turbine that is mounted on an airframe of an aircraft; a lubricating oil supply pipe that is connected to the gas turbine and through which a lubricating oil flows; a variable capacity type electric pump that is provided in the lubricating oil supply pipe and supplies the lubricating oil to the gas turbine; a temperature detection unit that detects a temperature of the lubricating oil supplied to the gas turbine; a supply amount detection unit that detects a supply amount of the lubricating oil supplied to the gas turbine by the electric pump; a rotation speed detection unit that detects a rotation speed of the gas turbine; and a control unit that controls a discharge amount of the lubricating oil from the electric pump based on detection results from the temperature detection unit, the supply amount detection unit, and the rotation speed detection unit, in which the control unit sets a target supply amount of the lubricating oil based on the rotation speed of the gas turbine detected by the rotation speed detection unit and the temperature of the lubricating oil detected by the temperature detection unit, and controls the discharge amount of the lubricating oil by feedback-controlling the rotation speed of the electric pump such that the supply amount of the lubricating oil detected by the supply amount detection unit matches the target supply amount.

(2) In the aircraft internal combustion engine according to the aspect of the above (1), the supply amount detection unit may be a pressure sensor that detects a pressure of the lubricating oil discharged from the electric pump, and the control unit may set a target pressure of the lubricating oil based on the rotation speed of the gas turbine and the temperature of the lubricating oil, and may feedback-control the rotation speed of the electric pump such that the pressure of the lubricating oil detected by the pressure sensor matches the target pressure.

(3) In the aircraft internal combustion engine according to the aspect of the above (1) or (2), after the gas turbine is stopped, the control unit may perform motoring of the gas turbine with electric power from a power source and also supply a predetermined amount of the lubricating oil from the electric pump in conjunction with the motoring.

(4) In the aircraft internal combustion engine according to the aspect of the above (3), the control unit may measure a temperature change of the lubricating oil detected by the temperature detection unit during an operation of the motoring, and control the discharge amount of the lubricating oil from the electric pump according to the temperature change.

According to the aspect of the above (1), the lubricating oil is supplied to the gas turbine by using the variable capacity type electric pump. The amount of the lubricating oil discharged from the electric pump is controlled by the control unit. The control unit first sets the target supply amount of the lubricating oil based on the temperature of the lubricating oil and the rotation speed of the gas turbine. Thereafter, the control unit feedback-controls the rotation speed of the electric pump such that the current supply amount of the lubricating oil detected by the supply amount detection unit matches the target supply amount. Consequently, the amount of lubricating oil supplied from the electric pump to the gas turbine is accurately controlled by the control unit, and thus an appropriate amount of the lubricating oil can be stably supplied to the gas turbine without excess or deficiency. The control unit performs feedback control with respect to the target supply amount such that the current supply amount of the lubricating oil detected by the supply amount detection unit matches the target supply amount. Consequently, even more accurate control can be performed based on the current supply amount of the lubricating oil.

The target supply amount is set based on the temperature of the lubricating oil and the rotation speed of the gas turbine. Therefore, for example, in a case where the engine load is small (in a case where the required oil amount is small), the value of the target supply amount can be reduced. Therefore, it is possible to suppress wasteful consumption of driving electric power of the electric pump, particularly in a case where an engine load is small, compared with the related art in which a constant amount of a lubricating oil is supplied by the electric pump regardless of a rotation speed thereof. It is possible to improve the fuel consumption rate compared with the related art by reducing the driving electric power of the electric pump.

Therefore, it is possible to provide the aircraft internal combustion engine that can improve the fuel consumption rate.

According to the aspect of the above (2), the supply amount detection unit is a pressure sensor that detects a pressure of the lubricating oil discharged from the electric pump. Consequently, it is possible to accurately measure the current supply amount of the lubricating oil with a simple configuration. The control unit sets the target pressure based on the rotation speed of the gas turbine and the temperature of the lubricating oil, and feedback-controls the electric pump such that the pressure of the lubricating oil detected by the pressure sensor matches the target pressure. Consequently, the control unit can accurately control the amount of the lubricating oil supplied from the electric pump to the gas turbine with the pressure as a parameter. Therefore, an appropriate amount of the lubricating oil can be stably supplied to the gas turbine without excess or deficiency.

According to the aspect of the above (3), the control unit performs motoring of the gas turbine after stopping the gas turbine. Consequently, the gas turbine can be cooled. The control unit starts motoring and supplies a predetermined amount of the lubricating oil from the electric pump in conjunction with the motoring. Consequently, it is possible to suppress the occurrence of caulking (oil adhesion) of the lubricating oil due to the supply of the lubricating oil being stopped immediately after the gas turbine is stopped. The gas turbine can be cooled more quickly during motoring by supplying the lubricating oil even after the gas turbine is stopped.

According to the aspect (4), the control unit controls the discharge amount of the lubricating oil from the electric pump according to the measured temperature change of the lubricating oil during the operation of the motoring. Consequently, an optimum amount of the lubricating oil can be supplied during the operation of the motoring. Therefore, it is possible to suppress the supply of an excessive amount of the lubricating oil and thus to suppress wasteful consumption of driving electric power of the electric pump. It is possible to further improve a fuel consumption rate compared with the related art by reducing the driving electric power of the electric pump.

### BRIEF DESCRIPTION OF THE DRAWINGS

FIG. 1 is an external view of an aircraft equipped with an internal combustion engine according to an embodiment.

FIG. 2 is a schematic configuration diagram of the internal combustion engine according to an embodiment.

FIG. 3 is a graph showing a relationship between an oil pressure in the internal combustion engine, a rotation speed of a gas turbine, and a rotation speed of an electric pump according to the embodiment.

FIG. 4 is a flowchart showing a flow of feedback control by a control unit according to an embodiment.

FIG. 5 is a graph showing a relationship between a rotation speed of a gas turbine and an oil pressure according to the related art.

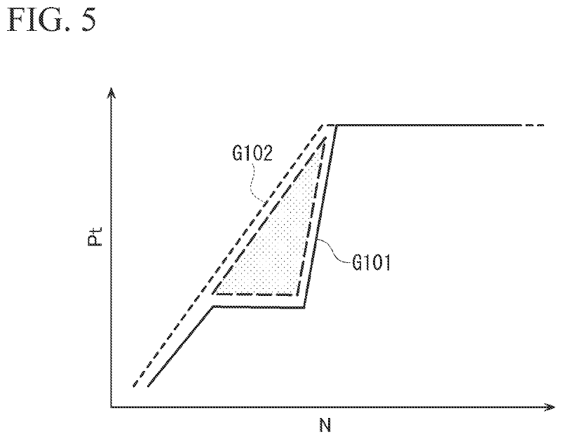

### DETAILED DESCRIPTION OF THE INVENTION

Hereinafter, an embodiment of the present invention will be described with reference to the drawings.

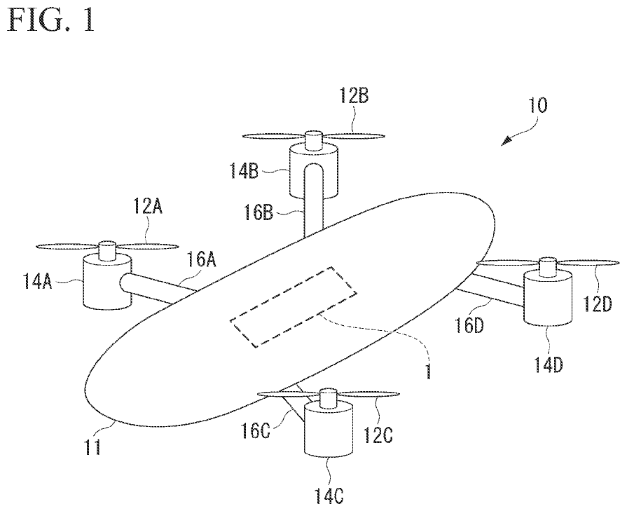

(Gas Turbine System) FIG. 1 is an external view of an aircraft 10 equipped with an aircraft internal combustion engine 1 according to an embodiment (hereinafter, also simply referred to as an internal combustion engine 1).

The aircraft 10 includes, for example, an airframe 11, a plurality of rotors 12A to 12D, a plurality of electric motors 14A to 14D, attachment members 16A to 16D, and the internal combustion engine 1. Hereinafter, in a case where the plurality of rotors 12A to 12D are not distinguished from each other, they will be referred to as rotors 12, and in a case where the plurality of electric motors 14A to 14D are not distinguished from each other, they will be referred to as electric motors 14.

The rotor 12A is attached to the airframe 11 via the attachment member 16A. The electric motor 14A is attached to a base (rotating shaft) of the rotor 12A. The electric motor 14A drives the rotor 12A. The electric motor 14A is, for example, a brushless DC motor. The rotor 12A is a fixed blade of a blade that rotates about an axis parallel to the direction of gravity in a case where the aircraft 10 is in a horizontal posture. The rotors 12B to 12D, the attachment members 16B to 16D, and the electric motors 14B to 14D also have the same functional configurations as described above, and thus description thereof will be omitted.

The rotors 12 rotate in response to a control signal, and thus the aircraft 10 flies in a desired flight state. The control signal is a signal for controlling the aircraft 10 based on an operation of an operator or an instruction in autopilot. For example, the rotor 12A and the rotor 12D rotate in a first direction (for example, clockwise), and the rotor 12B and the rotor 12C rotate in a second direction (for example, counterclockwise), so that the aircraft 10 flies. In addition to the rotors 12 described above, an auxiliary rotor for maintaining a posture or for horizontal propulsion (not shown) may be provided.

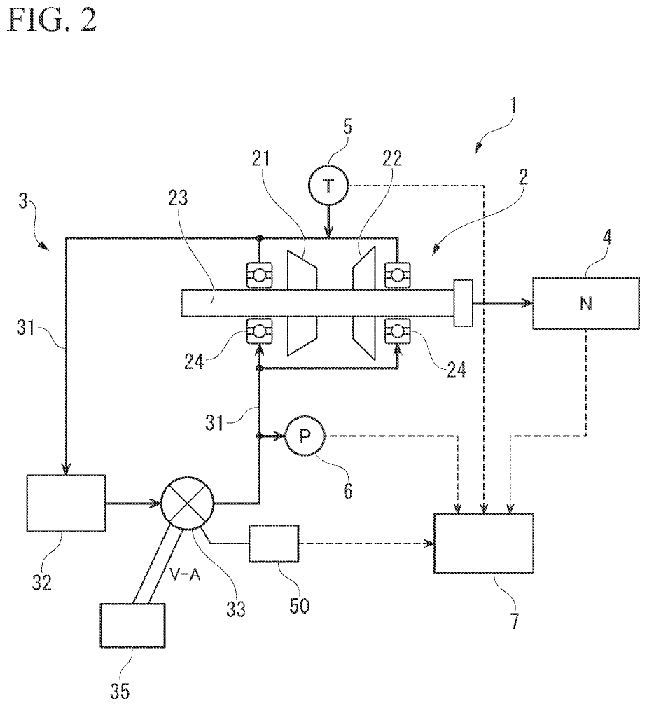

FIG. 2 is a schematic configuration diagram of the internal combustion engine according to an embodiment.

The internal combustion engine 1 is an aircraft internal combustion engine 1 mounted inside the aircraft 10. The internal combustion engine 1 generates electric power that serves as a power source for driving the rotors 12A to 12D (refer to FIG. 1) of the aircraft 10 described above. The internal combustion engine 1 is formed of a so-called gas turbine engine. The internal combustion engine 1 includes a gas turbine 2, a lubrication device 3, a rotation speed detection unit 4, a temperature detection unit 5, a supply amount detection unit 6, and a control unit 7.

The gas turbine 2 has a compressor 21, a turbine 22, a shaft 23, and bearings 24. The compressor 21 compresses intake air sucked from ventilation holes (not shown) provided in the airframe 11 of the aircraft 10. The turbine 22 is connected to the compressor 21 and rotates integrally with the compressor 21. The shaft 23 connects the compressor 21 to the turbine 22. The bearings 24 are disposed on an outer circumferential portion of the shaft 23. A generator (not shown) provided coaxially with the shaft 23 is connected to the shaft 23 of the gas turbine 2. The generator is connected to the shaft 23 via a speed reduction mechanism or the like. The generator generates electric power (AC power) by driving the turbine 22. AC power generated by the generator is converted into DC power by a converter of a power drive unit (PDU) (not shown) and stored in a battery 35. The electric motor 14 is driven by electric power output from the battery 35 being supplied to the electric motor 14. Instead of the battery 35, electric power may be directly supplied to the electric motor 14 from the generator of the gas turbine 2.

The lubrication device 3 circulates a lubricating oil to supply the lubricating oil to the gas turbine 2. The lubrication device 3 includes an oil tank 32, a lubricating oil supply pipe 31, and an electric pump 33.

The oil tank 32 stores the lubricating oil. One end of the lubricating oil supply pipe 31 communicates with the oil tank 32, and the other end of the lubricating oil supply pipe 31 is connected to the gas turbine 2. The lubricating oil flows inside the lubricating oil supply pipe 31.

The electric pump 33 is provided in the middle of the lubricating oil supply pipe 31. The electric pump 33 is driven by electric power from the battery 35. Instead of the battery 35, electric power may be directly supplied to the electric pump 33 from the generator of the gas turbine 2. The electric pump 33 sucks the lubricating oil from the oil tank 32 and circulates the lubricating oil inside the lubricating oil supply pipe 31. The electric pump 33 supplies the lubricating oil to the gas turbine 2. The lubricating oil that has flowed through the lubricating oil supply pipe 31 by the electric pump 33 is supplied particularly toward the bearing 24 of the gas turbine 2. Consequently, seizure of the bearings 24 is suppressed and the gas turbine 2 is cooled. The electric pump 33 is a variable capacity type electric pump 33 in which an amount of the lubricating oil supplied to the gas turbine 2 can be changed according to a signal from the control unit 7 that will be described in detail later.

The rotation speed detection unit 4 detects a rotation speed N of the gas turbine 2. The rotation speed detection unit 4 is, for example, a rotation speed sensor such as a resolver attached to the shaft 23 of the gas turbine 2.

The temperature detection unit 5 detects a temperature T of the lubricating oil supplied to the gas turbine 2. The temperature detection unit 5 is, for example, a temperature sensor that measures the temperature T of the lubricating oil in the vicinity of the bearings 24.

The supply amount detection unit 6 detects a supply amount S of the lubricating oil supplied to the gas turbine 2 by the electric pump 33. In the present embodiment, the supply amount detection unit 6 is, for example, a pressure sensor provided in the lubricating oil supply pipe 31 located further upstream than the gas turbine 2. That is, the supply amount detection unit 6 calculates the supply amount S of the lubricating oil from a pressure P of the lubricating oil in the lubricating oil supply pipe 31.

The control unit 7 is connected to each of the electric pump 33, the rotation speed detection unit 4, the temperature detection unit 5, and the supply amount detection unit 6. The control unit 7 acquires information (the rotation speed N of the gas turbine 2, the temperature T of the lubricating oil, and the pressure P of the lubricating oil) detected by the rotation speed detection unit 4, the temperature detection unit 5, and the supply amount detection unit 6. The control unit 7 acquires information such as a rotation speed of the electric pump 33 via a driver 50. The control unit 7 controls a discharge amount of the lubricating oil from the electric pump 33 by transmitting a signal to the electric pump 33 to control a rotation speed of the electric pump. The control unit 7 controls the discharge amount of the lubricating oil from the electric pump 33 based on the detection results from the rotation speed detection unit 4, the temperature detection unit 5, and the supply amount detection unit 6.

Specifically, the control unit 7 sets a target supply amount St of the lubricating oil based on the rotation speed N of the gas turbine 2 detected by the rotation speed detection unit 4 and the temperature T of the lubricating oil detected by the temperature detection unit 5. The control unit 7 feedback-controls the rotation speed of the electric pump 33 such that the supply amount S of the lubricating oil detected by the supply amount detection unit 6 matches the target supply amount St. In the present embodiment, the target supply amount St is set as a target pressure Pt. Therefore, in the present embodiment, the control unit 7 sets the target pressure Pt based on the rotation speed N of the gas turbine 2 and the temperature T of the lubricating oil, and feedback-controls the rotation speed of the electric pump 33 such that the pressure P of the lubricating oil detected by the pressure sensor matches the target pressure Pt.

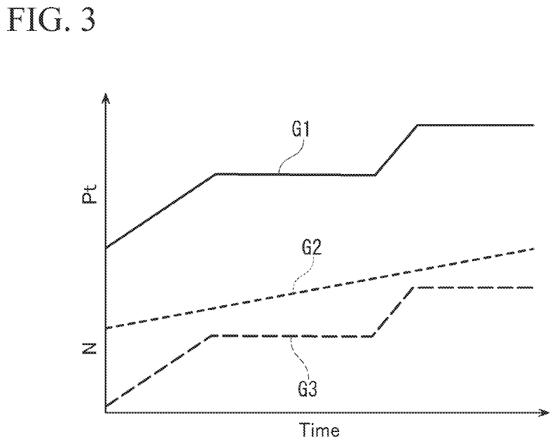

FIG. 3 is a graph showing a relationship between an oil pressure in the internal combustion engine 1 according to the embodiment, the rotation speed N of the gas turbine 2, and a rotation speed of the electric pump 33. The graph G1 of FIG. 3 indicates a change over time in the target pressure Pt set by the control unit 7. The graph G2 indicates a change over time in the rotation speed N of the gas turbine 2. The graph G3 indicates a change over time in a rotation speed of the electric pump 33 controlled by the control unit 7.

As indicated in the graphs G1 and G2, the control unit 7 sets the target pressure Pt such that an operation is performed in proportion to the rotation speed N of the gas turbine 2. This target pressure Pt is set to match the required oil pressure of the internal combustion engine 1. As indicated in the graph G3, the rotation speed of the electric pump 33 is controlled based on the target pressure Pt, and thus the electric pump 33 can operate in proportion to the rotation speed N of the gas turbine 2. The control unit 7 controls the rotation speed of the electric pump 33 as described above, and thus it is possible to reduce driving electric power of the electric pump 33 while suppressing friction with the minimum necessary oil pressure.

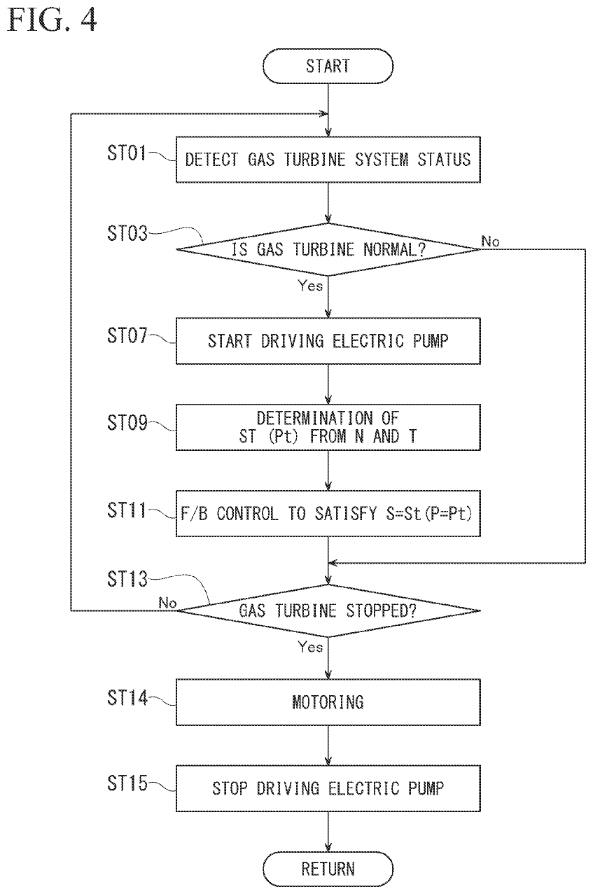

FIG. 4 is a flowchart showing a flow of feedback control by the control unit 7 according to the embodiment.

The flow of control by the control unit 7 will be described in more detail with reference to FIG. 4.

The internal combustion engine 1 (gas turbine 2) is being driven in a state before the flow in FIG. 4 is started. When the flow related to the control unit 7 is started, first, the control unit 7 detects a system state of the gas turbine 2 (ST01). Next, the control unit 7 determines whether or not the system state of the gas turbine 2 is normal (ST03). In a case where it is determined that the system state of the gas turbine 2 is not normal (No in ST03), the control unit 7 considers that there is a request for stopping the gas turbine 2 and stops the gas turbine 2 (Yes in ST13).

In a case where it is determined in step ST03 that the system state of the gas turbine 2 is normal (Yes in ST03), the control unit 7 drives the electric pump 33 (ST07). Next, the control unit 7 acquires the rotation speed N of the gas turbine 2 from the rotation speed detection unit 4 and the temperature T of the lubricating oil from the temperature detection unit 5. The control unit 7 calculates the target supply amount St based on the acquired rotation speed N of the gas turbine 2 and the temperature T of the lubricating oil (ST09). In the present embodiment, the control unit 7 calculates the target pressure Pt based on the rotation speed N of the gas turbine 2 and the temperature T of the lubricating oil.

Next, the control unit 7 acquires the supply amount S of the lubricating oil supplied to the gas turbine 2 from the supply amount detection unit 6. The control unit 7 compares the acquired supply amount S of the lubricating oil with the target supply amount St calculated in step ST09, and feedback-controls a rotation speed of the electric pump 33 such that the supply amount S of the lubricating oil matches the target supply amount St (ST11). In the present embodiment, the pressure P of the lubricating oil is acquired as a parameter of the supply amount S. Therefore, in step ST11, the control unit 7 compares the acquired pressure P of the lubricating oil with the target pressure Pt calculated in step ST09, and feedback-controls a rotation speed of the electric pump 33 such that the pressure P of the lubricating oil matches the target pressure Pt.

Next, the control unit 7 determines whether or not there is a stop request for the gas turbine 2 (ST13). In a case where there is a stop request (Yes in ST13), driving of the gas turbine 2 is stopped. Thereafter, the control unit 7 performs motoring of the gas turbine 2 as will be described in detail later (ST14). If the motoring is completed, the control unit 7 stops the supply of the lubricating oil by stopping the driving of the electric pump 33, and finishes this flow (ST15).

On the other hand, if there is no stop request for the gas turbine 2 in step ST13 (No in ST13), the process returns to step ST01, and the above flow is repeated until there is a stop request for the gas turbine 2.

Here, control of the control unit 7 during motoring of the gas turbine 2 in step ST14 will be described in detail. In step ST14, after stopping the gas turbine 2, the control unit 7 performs motoring of the gas turbine 2 to cool it with electric power from a power source (not shown). In this case, the control unit 7 supplies a predetermined amount of lubricating oil from the electric pump 33 to the gas turbine 2 in conjunction with the motoring. Specifically, first, the control unit 7 acquires a temperature change of the lubricating oil detected by the temperature detection unit 5 during the operation of the motoring. The control unit 7 controls a discharge amount of the lubricating oil from the electric pump 33 according to the acquired temperature change of the lubricating oil.

Next, control by the control unit 7 when the gas turbine 2 is started again after the gas turbine 2 is stopped will be described.

In the present embodiment, the control unit 7 first drives the electric pump 33 and supplies the lubricating oil to the gas turbine 2 before starting the gas turbine 2. After a predetermined time has elapsed from the start of driving the electric pump 33 and an amount of the lubricating oil discharged from the electric pump 33 reaches a desired value, the control unit 7 starts driving the gas turbine 2. After the gas turbine 2 starts driving, the control unit 7 starts feedback control for the electric pump 33 based on the above flow (refer to FIG. 4).

### Advantageous Effects

Next, advantageous effects of the above-described internal combustion engine 1 will be described.

According to the internal combustion engine 1 of the present embodiment, the lubricating oil is supplied to the gas turbine 2 by using the variable capacity type electric pump 33. An amount of the lubricating oil discharged from the electric pump 33 is controlled by the control unit 7. First, the control unit 7 sets the target supply amount St of the lubricating oil based on the temperature T of the lubricating oil and the rotation speed N of the gas turbine 2. Thereafter, the control unit 7 feedback-controls a rotation speed of the electric pump 33 such that the current supply amount S of the lubricating oil detected by the supply amount detection unit 6 matches the target supply amount St. Consequently, the supply amount S of the lubricating oil from the electric pump 33 to the gas turbine 2 is accurately controlled by the control unit 7, and thus an appropriate amount of lubricating oil can be stably supplied to the gas turbine 2 without excess or deficiency. The control unit 7 performs feedback control with respect to the target supply amount St such that the current supply amount S of the lubricating oil detected by the supply amount detection unit 6 matches the target supply amount St. Consequently, it is possible to perform more accurate control based on the current supply amount S of the lubricating oil.

The target supply amount St is set based on the temperature T of the lubricating oil and the rotation speed N of the gas turbine 2. Therefore, for example, in a case where an engine load is small (in a case where the required oil amount is small), a value of the target supply amount St can be reduced. Therefore, it is possible to suppress wasteful consumption of driving electric power of the electric pump 33, particularly in a case where an engine load is small, compared with the related art in which a constant amount of a lubricating oil is supplied by the electric pump 33 regardless of a rotation speed thereof. It is possible to improve a fuel consumption rate compared with the related art by reducing the driving electric power of the electric pump 33.

Therefore, it is possible to provide the aircraft internal combustion engine 1 that can improve the fuel consumption rate.

The supply amount detection unit 6 is a pressure sensor that detects the pressure P of the lubricating oil discharged from the electric pump 33. Consequently, it is possible to accurately measure the current supply amount S of the lubricating oil with a simple configuration. The control unit 7 sets the target pressure Pt based on the rotation speed N of the gas turbine 2 and the temperature T of the lubricating oil, and feedback-controls the electric pump 33 such that the pressure P of the lubricating oil detected by the pressure sensor matches the target pressure Pt. Consequently, the control unit 7 can accurately control the amount S of the lubricating oil supplied from the electric pump 33 to the gas turbine 2 with the pressure P as a parameter. Therefore, an appropriate amount of the lubricating oil can be stably supplied to the gas turbine 2 without excess or deficiency.

The control unit 7 performs motoring of the gas turbine 2 after stopping the gas turbine 2. Consequently, the gas turbine 2 can be cooled. The control unit 7 starts motoring, and supplies a predetermined amount of the lubricating oil from the electric pump 33 in conjunction with the motoring. Consequently, it is possible to suppress the occurrence of caulking (oil adhesion) of the lubricating oil due to the supply of the lubricating oil being stopped immediately after the gas turbine 2 is stopped. The gas turbine 2 can be cooled more quickly during motoring by supplying the lubricating oil even after the gas turbine 2 is stopped.

The control unit 7 controls an amount of the lubricating oil discharged from the electric pump 33 according to a measured temperature change of the lubricating oil during the operation of the motoring. Consequently, an optimum amount of lubricating oil can be supplied during the operation of the motoring. Therefore, it is possible to suppress the supply of an excessive amount of the lubricating oil and thus to suppress wasteful consumption of driving electric power of the electric pump 33. It is possible to further improve a fuel consumption rate by reducing the driving electric power of the electric pump 33 compared with the related art.

When the internal combustion engine 1 is started, the control unit 7 drives the electric pump 33 first, and then starts driving the gas turbine 2. Consequently, lubrication can be started early when the internal combustion engine 1 is started. Therefore, friction immediately after the gas turbine 2 is driven can be reduced compared with a case where the lubrication is started after the gas turbine 2 is driven.

The technical scope of the present invention is not limited to the above-described embodiment, and various modifications can be made without departing from the concept of the present invention.

For example, the supply amount detection unit 6 may have a configuration other than the pressure sensor. The supply amount detection unit 6 may be, for example, a flow meter. The supply amount detection unit 6 may be configured to calculate the supply amount S of the lubricating oil by acquiring, for example, a rotation speed of the pump. The supply amount detection unit 6 may be configured to calculate the supply amount S of the lubricating oil by acquiring, for example, power consumption of the battery 35 that drives the pump.

The temperature detection unit 5 may measure the temperature of, for example, the compressor 21, the turbine 22, or the shaft 23 of the gas turbine 2. The temperature detection unit 5 may measure the temperature of, for example, the lubricating oil after being discharged from the gas turbine 2, that is, the lubricating oil flowing in the lubricating oil supply pipe 31 located further downstream than the gas turbine 2.

The constituents in the above-described embodiments may be replaced with well-known constituents as appropriate without departing from the concept of the present invention, and the above-described embodiments may be combined as appropriate.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Internal combustion engine
2 Gas turbine
4 Rotation speed detection unit
5 Temperature detection unit
6 Supply amount detection unit
7 Control unit
10 Aircraft
11 Airframe
31 Lubricating oil supply pipe
33 Electric pump
N Rotation speed (of gas turbine)
P Pressure (of lubricating oil)
Pt Target pressure
S Supply amount (of lubricating oil)
St Target supply amount
T Temperature (of lubricating oil)

What is claimed is:

1. An aircraft internal combustion engine comprising:
a gas turbine that is mounted on an airframe of an aircraft;
a lubricating oil supply pipe that is connected to the gas turbine and through which a lubricating oil flows;
a variable capacity type electric pump that is provided in the lubricating oil supply pipe and supplies the lubricating oil to the gas turbine;
a temperature detection unit that detects a temperature of the lubricating oil supplied to the gas turbine;
a supply amount detection unit that detects a supply amount of the lubricating oil supplied to the gas turbine by the electric pump;
a rotation speed detection unit that detects a rotation speed of the gas turbine; and
a control unit that controls a discharge amount of the lubricating oil from the electric pump based on detection results from the temperature detection unit, the supply amount detection unit, and the rotation speed detection unit,
wherein the control unit
sets a target supply amount of the lubricating oil based on the rotation speed of the gas turbine detected by the rotation speed detection unit and the temperature of the lubricating oil detected by the temperature detection unit, and
controls the discharge amount of the lubricating oil by feedback-controlling the rotation speed of the electric pump such that the supply amount of the lubricating oil detected by the supply amount detection unit matches the target supply amount.

2. The aircraft internal combustion engine according to claim 1,
wherein the supply amount detection unit is a pressure sensor that detects a pressure of the lubricating oil discharged from the electric pump, and
wherein
the control unit sets a target pressure of the lubricating oil based on the rotation speed of the gas turbine and the temperature of the lubricating oil, and
the control unit feedback-controls the rotation speed of the electric pump such that the pressure of the lubricating oil detected by the pressure sensor matches the target pressure.

3. The aircraft internal combustion engine according to claim 1,
wherein, after the gas turbine is stopped, the control unit performs motoring of the gas turbine with electric power from a power source, and also supplies a predetermined amount of the lubricating oil from the electric pump in conjunction with the motoring.

4. The aircraft internal combustion engine according to claim 3,
wherein the control unit
measures a temperature change of the lubricating oil detected by the temperature detection unit during an operation of the motoring, and
controls the discharge amount of the lubricating oil from the electric pump according to the temperature change.

5. The aircraft internal combustion engine according to claim 2,
wherein, after the gas turbine is stopped, the control unit performs motoring of the gas turbine with electric power from a power source, and also supplies a predetermined amount of the lubricating oil from the electric pump in conjunction with the motoring.

6. The aircraft internal combustion engine according to claim 5,
wherein the control unit
measures a temperature change of the lubricating oil detected by the temperature detection unit during an operation of the motoring, and
controls the discharge amount of the lubricating oil from the electric pump according to the temperature change.
